(19) United States
(12) Patent Application Publication
(10) Pub. No.: US 2017/0104213 A1
(43) Pub. Date: Apr. 13, 2017

(54) METHOD FOR MANUFACTURING NEGATIVE PLATE OF SECONDARY BATTERY

(71) Applicant: Metal Industries Research & Development Centre, Kaohsiung (TW)

(72) Inventors: Chia-Hung HUANG, Kaohsiung (TW); Sung-Mao CHIU, Kaohsiung (TW); Chi-Wen CHU, Kaohsiung (TW); Yin CHUANG, Kaohsiung (TW); Chun-Chieh WANG, Kaohsiung (TW); Chia-Min WEI, Kaohsiung (TW)

(21) Appl. No.: 14/969,112

(22) Filed: Dec. 15, 2015

(30) Foreign Application Priority Data
Oct. 13, 2015 (TW) 104133524

(51) Int. Cl. H01M 4/587; H01M 4/36; C01B 31/04; H01M 4/1393; H01M 4/133; H01M 4/04; H01M 4/66; H01M 10/0525

(52) U.S. Cl. CPC H01M 4/587; H01M 4/661; H01M 4/366; H01M 10/0525; H01M 4/1393; H01M 4/133; H01M 4/0404; H01M 4/043; C01B 31/0484; H01M 2004/027

(57) ABSTRACT

The present invention provides a method for manufacturing a negative plate of a secondary battery, which includes the following steps: providing multiple sheets of functional graphene; compressing the functional graphene to form a graphene target; providing copper foil, and forming a microstructure on a surface of the copper foil, so as to strengthen attachment between a graphene layer and the copper foil; depositing the graphene target on the microstructure of the surface of the copper foil, to form the graphene layer; and repairing the graphene layer by using an excimer laser. The foregoing manufacturing method can greatly prolong a cycle life of the whole graphene cathode, and increase a reversible capacitance of a battery.

### BACKGROUND

Technical Field

The present invention relates to a method for manufacturing a negative plate of a secondary battery, and in particular, to a method for manufacturing a negative plate of a secondary battery, where defects inside graphene are structurally recovered by using an excimer laser, so that a cycle life of an entire graphene cathode can be greatly prolonged and a reversible capacitance of the battery can be increased.

Related Art

In the prior art, a solid electrolyte interface film (SEI film) is formed on a surface of a negative plate, so that when solvating lithium ions in an electrolyte enters the negative plate through the SEI film, the lithium ions are separated from solvating solvent molecules without bringing a delamination problem to the negative plate. An existing SEI film is classified into two kinds: a reactive SEI film and a reduction SEI film, However, these SEI films are added into an electrolyte in the form of an additive. The SEI film is formed through polymerization after an electrochemical reaction, and is attached to the surface of the negative plate. Therefore, a polymerization effect thereof and a capability of separation from the solvent molecules are subject to an electrochemical polymerization effect of the SEI film, In addition, the forming the SEI film on the surface of the negative plate easily brings a dissolution phenomenon to the electrolyte, which affects electrical performance of a lithium battery. Moreover, the SEI film is coated on the negative plate in an attraction manner, and is easily separated from the negative plate under a high-temperature operation. Therefore, an attraction capability of the SEI film also affects its capability of separation from the solvent molecules. In addition, gas is easily produced when the SEI film is formed through polymerization, which also affects the whole performance of the SEI film.

A conventional technology for manufacturing graphene includes methods such as mechanical exfoliation, epitaxial growth, chemical vapor deposition (CVD), and chemical exfoliation. Graphene with high quality can be produced by using the mechanical exfoliation and the epitaxial growth, but large-area graphene cannot be synthesized with these two methods; due to a high cost, it is difficult to apply the CVD and the chemical exfoliation in manufacturing of electromobile battery material.

With respect to application of the lithium battery, the graphene is regarded as a new-generation cathode material; graphite is taken as the principal commercial cathode material at present, and has high stability and high coulombic efficiency, but its electric capacity is subject to a theoretical capacitance (372 mAh/g, LiC6). To improve the electric capacity thereof, many researches attempt to produce defects or a functional group on the surface of the graphite, but achievements are limited; recent documents also discuss the energy storage feature of the graphene material, and it is found that a wider graphite interlayer spacing and a higher single-layer graphite sheet allow more lithium ions to undergo an intercalation reaction, so as to improve the energy storage feature of the material. The Honma research team shows that a capacitance of the cathode of the graphene may reach 540 mAh/g, and has a certain cycle life. In addition, if C60 and carbon nanotubes (CNTs) are introduced into a graphene manufacturing process to form a composite material so as to cause change of a microstructure, a capacitance of the material can be increased to. 730 mAh/g and 784 mAh/g separately, which further verifies that the carbon material has a higher electric capacity when having a larger interlayer spacing. Moreover, the team further uses reactive stannic oxide (SnO₂) and graphene to form a composite electrode, a three-dimensional buffering structure can be generated, and the whole cycle life can be further prolonged. Although the existing graphene has rather unique features and accordingly has an application potential, its application in the lithium battery still brings a defect of a high irreversible capacitance caused by a high oxygen-contained functional group and a larger area.

At present, fabrication of graphene mostly uses a method disclosed by Hummers in 1957, where graphite is first oxidized into graphite oxide by using strong acid, where the use of the strong acid aims to increase the interlayer spacing (0.335 nm or 0.6 to 1.1 nm) of graphene generated later, and further reduce a bond (7 MPa or 2.6 MPa) between layers; the graphite oxide formed by using the strong acid is composed of multiple graphene oxide sheets, an oxygen-contained functional group thereof attached after chemical modification renders the graphite oxide hydrophilic, such a hydrophilic feature enables water molecules or other intercalating agents to enter graphene layers, and then graphite intercalation composites (GICs) are formed; and finally, after a rapid temperature rise, the GICs are inflated in a c-axis direction by instantaneous evaporation of the intercalating agents, and then a graphene oxide thin film is exfoliated. Therefore, intercalants are added; and are vaporized by rapid heating, and a volume expansion ratio after the vaporization reaches up to 300 times; and then nano graphene plates are obtained after reduction and decentralization. At present, a bottleneck of this manufacturing technology lies in oxidization, reduction, and decentralization. When the strong acid is used to oxidize the graphene, hydroxyl and epoxide that are difficult to be reduced are formed on the surface of the graphene, which affects electric conductivity of the material; in addition, because surfaces of graphite oxide and graphite are both hydrophilic, during reduction, aggregation, that is, a decentralization difficulty mentioned above, is easily caused by conversion between hydrophilicity and hydrophobicity of the material surface; and a large amount of deionized water is needed to clean the material if the strong acid is used for treatment, which is not environmentally friendly. In addition, graphite is incompletely exfoliated; it is reported in a document that a surface area of the fabricated graphene is about 100 m²/g to 500 m²/g and a size thereof is 13*52 nm, and there is a gap between these values and theoretical values.

U.S. Pat. No. 7,745,047 B2 discloses a fabrication method of a cathode material of a lithium battery, where a precursor of graphite oxide and different cathode materials are mixed and heated, and graphene is formed after exfoliation/reduction. However, an ECG manufacturing process requires multiple chemical steps, and easily causes environmental pollution; and quality of the graphene is easily affected by a raw material status, an exfoliation procedure, and a reduction condition, and therefore, it is difficult to stably control this process. Therefore, when this method is applied in industrial mass production of ECG-surface modified cathode and anode materials, product properties cannot be maintained.

U.S. Pat. No. 1,447,993 describes a cathode material and a negative plate, and discloses a cathode material with a self-repair capability and a negative plate, where an unsaturated-compound functional group and carbon-contained substrate surface undergo an addition reaction, to form a chemical bond, for example, a chemical covalent bond, where this addition reaction mechanism is reversible. When a partial high-molecular cross-linked structure of unsaturated compound bonded to the carbon-contained substrate surface is broken due to an external factor (for example, heat or stress), because of the reversible mechanism of the addition reaction, the broken cross-linked structure undergoes an addition reaction again in a manner of providing high-molecular energy (for example, heating), so as to recover to an original structure; therefore, on the carbon-contained substrate surface, a protective layer formed by the unsaturated compound chemically bonded to the carbon-contained substrate surface has a self-repair capability. In addition, the protective layer formed by the unsaturated compound on the carbon-contained substrate can improve the electrochemical activity of the carbon surface, perfect compatibility between the carbon-contained substrate surface and an electrolyte interface, and further maintain integrality of the original substrate.

U.S. Pat. No. 1,480,426 describes a graphene manufacturing method, where the method includes: setting a first electrode and a second electrode in an electrolyte, where ions in the electrolyte are used as inserts and the first electrode is a graphite material; performing a step of intercalation of the graphite material under a first bias; performing a step of exfoliation of the graphite material by using the inserts under a second bias; and finally, taking a solid part from the electrolyte as electrochemical graphene. An oxygen content in the electrochemical graphene obtained by using this method is far below that in the graphene (ECG) obtained by using chemical exfoliation, and therefore, conductivity of the electrochemical graphene is much higher than that of the ECG, and the electron conduction velocity is further enhanced.

To sum up, in the prior art, the SET film is coated on a negative plate in an attraction manner, and therefore is easily separated from the negative plate; and its application in a lithium battery still brings a defect of a high irreversible capacitance caused by a high oxygen-contained functional group and a larger area; moreover, in an oxidization, reduction, and decentralization reaction, when strong acid is used to oxidize the graphene, hydroxyl and epoxide that are difficult to be reduced are formed on the surface of the graphene, which affects conductivity of the material.

### SUMMARY

An objective of the present invention provides a method for manufacturing a negative plate of a secondary battery, which fabricates a coarse surface microstructure on a surface of copper foil, so as to increase a surface area of the copper foil to strengthen attachment between graphene and the copper foil; and then after deposition of graphene, repairs, by using an excimer laser, a defect structure inside the graphene deposited on the copper foil. The method can increase a reversible capacitance of a battery and greatly prolong a cycle life of the whole graphene cathode.

The method for manufacturing a negative plate of a secondary battery according to the present invention comprises the following steps: providing multiple sheets of functional graphene; compressing the functional graphene to form a graphene target; providing copper foil, and forming a microstructure on a surface of the copper foil, so as to strengthen attachment between a graphene layer and the copper foil; depositing the graphene target on the microstructure of the surface of the copper foil, to form the graphene layer; and repairing the graphene layer by using an excimer laser,

As described above, in the method for manufacturing a negative plate of a secondary battery according to the present invention, coarse surface is fabricated on a surface of copper foil by using a femtosecond laser; preferably, a subtler microstructure is further fabricated by using a picosecond laser, and then, a graphene target is deposited on the copper foil to form a graphene layer; and finally, a defect structure of graphene is repaired by using an excimer laser. In this way, by using the microstructure fabricated on the coarse surface of the copper foil, attachment between the graphene and the copper foil can be improved; and finally the defect structure inside the graphene is repaired by using the excimer laser, which can increase a reversible capacitance of a battery and greatly prolong a cycle life of the whole graphene cathode.

With the method for manufacturing a negative plate of a secondary battery according to the present invention, the graphene layer contains oxygen below 20 wt %, and has penetrability of 90% or higher and sheet resistance below 10 kΩ/sq, where the sheet resistance is calculated by taking the film thickness of the graphene as 1.5 nm to 5 nm.

### BRIEF DESCRIPTION OF THE DRAWINGS

FIG. 1 is a flowchart of a method for manufacturing functional graphene according to the present invention; and

FIG. 2 is a flowchart of a method for manufacturing a negative plate of a battery according to the present invention.

### DETAILED DESCRIPTION

To make the foregoing and other objectives, features, and advantages of the present invention more comprehensible, the present invention is described in detail below with reference to the accompanying drawings.

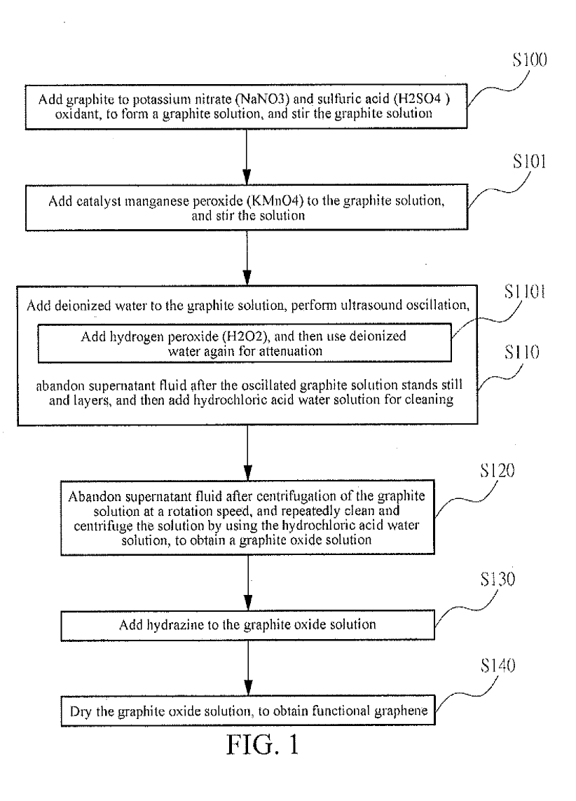

First, referring to FIG. 1, FIG. 1 is a flowchart of a method for manufacturing functional graphene according to the present invention. The method for manufacturing functional graphene includes: In Step S100, add graphite to potassium nitrate (NaNO₃) and sulfuric acid (H₂O₄) oxidant, to form a graphite solution, and stir the graphite solution. Then in Step S101, add catalyst manganese peroxide (KMnO₄) to the graphite solution, and stir the solution.

As described above, the graphite is 2 grams, manganese peroxide is 3 grams, potassium nitrate is 0.2 to 0.75 grams, sulfuric acid is 70 milliliters, stirring temperature is below 80° C., and a stirring time is 2 hours.

Then, in Step S110, add deionized water to the graphite solution, perform ultrasound oscillation, abandon supernatant fluid after the oscillated graphite solution stands still and layers, and then add hydrochloric acid water solution for cleaning, where a ratio of hydrochloric acid to water in the hydrochloric acid water solution is 1:10.

After the deionized water is added to the graphite solution, Step S1101 is further included, where hydrogen peroxide (H₂O₂) of 3 grams is added as a catalyst, then deionized water is used again for attenuation, and afterwards, ultrasound oscillation is performed, where an ultrasound oscillation time is 30 minutes.

Then, in Step S120, abandon supernatant fluid after centrifugation of the graphite solution at a rotation speed, and repeatedly clean and centrifuge the solution by using the hydrochloric acid water solution, to obtain a graphite oxide solution, where the rotation speed is about 4000 rpm and a centrifugation time is 5 minutes.

Then, in Step S130, add hydrazine to the graphite oxide solution, where the graphite oxide solution is 3000 CC; and the added 50 ml hydrazine is recirculated (recirculate to improve a reaction effect) for 24 hours at 100° C.

In Step S140, dry the graphite oxide solution, to obtain functional graphene, where the drying temperature is 100° C.

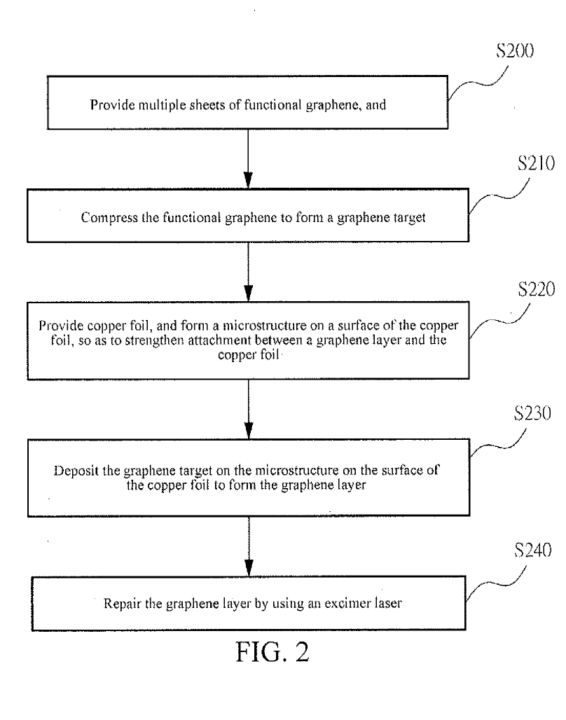

Then, a method for manufacturing a negative plate of a battery is performed. Referring to FIG. 2, FIG. 2 is a flowchart of a method for manufacturing a negative plate of a battery according to the present invention, First, Step S200 is performed, where multiple sheets of functional graphene is provided, and the functional graphene is compressed to form a graphene target (Step S210).

Then in step S220, provide copper foil, and form a microstructure on a surface of the copper foil. In this embodiment, the microstructure is formed on the surface of the copper foil by using a femtosecond laser, to coarsen the surface of the copper foil, where the microstructure is a trench structure or a ladder structure. Preferably, after the microstructure is formed on the surface of the copper foil by using the femtosecond laser, the surface of the copper foil is cut by using a picosecond laser to perform subtler processing, that is, a subtler microstructure is formed on the surface of the microstructure by using the picosecond laser, to increase a surface area of the copper foil, so as to strengthen attachment between a deposited graphene layer and the copper foil in a subsequent step.

Then, in Step S230, deposit the graphene target on the copper foil to form a graphene layer. In this way, because the coarse surface microstructure has been fabricated on the surface of copper foil, attachment between the graphene and the copper foil can be strengthened. Finally, in Step S240, repair the graphene layer on the copper foil by using an excimer laser. Because a lattice in the graphene target status presents a perfect hexagonal lattice and has better mechanical performance, a lattice of graphene formed through deposition on the microstructure of the copper foil later has defects, and presents a loose status. Therefore, after processing and annealing are performed on the graphene by using the excimer laser, the lattice thereof returns to the hexagonal lattice status after repairing, thereby increasing a reversible capacitance of a battery and greatly prolonging a cycle life of the whole graphene cathode.

With the method for manufacturing a negative plate of a secondary battery according to the present invention, the graphene layer contains oxygen below 20 wt %, and has penetrability of 90% or higher and sheet resistance below 10 kΩ/sq, where the sheet resistance is calculated by considering the graphene layer formed after a graphene target is deposited on the copper foil, where the film thickness of the graphene layer is 1.5 nm to 5 nm.

With the foregoing method in the present invention, a reversible capacitance of a battery is mainly increased. A charging capacitance at the first ring is greatly increased to 1333 mAh/g, a discharging capacitance is also increased to 643 mAh/g, and this value is 1.5 times greater than that of commercial graphite. For the cycle life of 100 rings, the capacitance can be increased from 200 mAh/g in the original situation to 450 mAh/g, which greatly prolongs the cycle life of the whole graphene cathode. Further, after charging and discharging for 200 rings, the capacitance hardly attenuates and reaches 648 mAh/g, which is beyond an index of a button cell and achieves an index of a vehicle battery cathode material.

In the present invention, a coarse surface microstructure is fabricated on a surface of copper foil by using a femtosecond laser and a picosecond laser, which strengthens attachment between a graphene layer and the copper foil; then, a graphene target is deposited on the copper coil to form the graphene layer; and finally, a defect structure of the graphene layer deposited on the copper foil is repaired by using an excimer laser, thereby increasing a reversible capacitance of a battery and greatly prolonging a cycle life of the whole graphene cathode.

To sum up, preferred implementation manners or embodiments of technical solutions adopted by the present invention to solve the problems are merely descried, and are not intended to limit the patent implementation scope of the present invention. Any implementation conforming to the patent implementation scope of the present invention, or equivalent variations and modifications made according to the patent scope of the present invention all fall within the patent scope of the present invention.

What is claimed is:

1. A method for manufacturing a negative plate of a secondary battery, comprising the following steps:
providing multiple sheets of functional graphene;
compressing the functional graphene to faun a graphene target;
providing copper foil, and forming a microstructure on a surface of the copper foil, so as to strengthen attachment between a graphene layer and the copper foil;
depositing the graphene target on the microstructure of the surface of the copper foil, to form the graphene layer; and
repairing the graphene layer by using an excimer laser.

2. The method for manufacturing a negative plate of a secondary battery according to claim 1, wherein in the step of forming a microstructure on a surface of the copper foil, the microstructure is formed on the surface of the copper foil by using a femtosecond laser.

3. The method for manufacturing a negative plate of a secondary battery according to claim 1, wherein the microstructure is a trench structure or a ladder structure.

4. The method for manufacturing a negative plate of a secondary battery according to claim 2, wherein the microstructure is a trench structure or a ladder structure.

5. The method for manufacturing a negative plate of a secondary battery according to claim 2, wherein after the microstructure is formed on the surface of the copper foil by using the femtosecond laser, a subtler microstructure is formed on the surface of the microstructure by using a picosecond laser.

6. The method for manufacturing a negative plate of a secondary battery according to claim 1, wherein a method for manufacturing functional graphene comprises:
adding graphite to potassium nitrate (NaNO₃) and sulfuric acid (H₂SO₄) oxidant, to form a graphite solution, and stirring the graphite solution;
adding deionized water to the graphite solution, performing ultrasound oscillation, abandoning supernatant fluid after the oscillated graphite solution stands still and layers, and then adding hydrochloric acid water solution for cleaning;
abandoning supernatant fluid after centrifugation of the graphite solution at a rotation speed, and repeatedly cleaning and centrifuging the solution by using the hydrochloric acid water solution, to obtain a graphite oxide solution;
adding hydrazine to the graphite oxide solution; and
drying the graphite oxide solution, to obtain functional graphene.

7. The method for manufacturing a negative plate of a secondary battery according to claim 2, wherein after the graphite is added to the potassium nitrate and the sulfuric acid oxidant, to form a graphite solution, the method further comprises: adding catalyst manganese peroxide (KMnO₄) to the graphite solution, and stirring the solution.

8. The method for manufacturing a negative plate of a secondary battery according to claim 2, wherein in the step of adding graphite to potassium nitrate and sulfuric acid oxidant, to form a graphite solution, and stirring the graphite solution, the graphite is 2 grams, potassium nitrate is 0.2 to 0.75 grams, sulfuric acid is 70 milliliters, and manganese peroxide is 3 grams, stirring temperature is below 80° C., and a stirring time is 2 hours.

9. The method for manufacturing a negative plate of a secondary battery according to claim 2, wherein in the step of adding deionized water to the graphite solution, performing ultrasound oscillation, abandoning supernatant fluid after the oscillated graphite solution stands still and layers, and then adding hydrochloric acid water solution for cleaning, after the deionized water is added to the graphite solution, the method further comprises: adding hydrogen peroxide (H₂O₂), and then using deionized water again for attenuation.

10. The method for manufacturing a negative plate of a secondary battery according to claim 2, wherein in the step of adding deionized water to the graphite solution, performing ultrasound oscillation, abandoning supernatant fluid after the oscillated graphite solution stands still and layers, and then adding hydrochloric acid water solution for cleaning, a ratio of hydrochloric acid to water in the hydrochloric acid water solution is 1:10.

11. The method for manufacturing a negative plate of a secondary battery according to claim 2, wherein in the step of adding hydrazine to the graphite oxide solution, the graphite oxide solution is 3000 CC; and the added 50 ml hydrazine is recirculated for 24 hours at 100° C.,
